(19) United States
(12) Patent Application Publication
(10) Pub. No.: US 2007/0082994 A1
(43) Pub. Date: Apr. 12, 2007

(54) Polymer-containing sulfosuccinate dispersions

(75) Inventors: Stefan Kirsch, Nieder-Olm (DE); Karl-Heinz Schumacher, Neustadt (DE); Alexander Centner, Rodersheim-Gronau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/579,096

(22) PCT Filed: Nov. 6, 2004
(86) PCT No.: PCT/EP04/12599

§ 371 Date: May 12, 2006

(30) Foreign Application Priority Data
Nov. 13, 2003 (DE) 10353201.3

(51) Int. Cl. C08K 5/09

(52) U.S. Cl. 524/395

(57) ABSTRACT

Method of enhancing the performance properties of aqueous polymer dispersions comprising water-soluble ionic compounds, which comprises removing at least 50 mol % of the water-soluble ionic compounds from the polymer dispersion and then adding at least one salt of a monoalkyl or dialkyl ester of a sulfonated dicarboxylic acid.

The invention relates to a method of enhancing the performance properties of aqueous polymer dispersions comprising water-soluble ionic compounds, which comprises removing at least 50 mol % of the water-soluble ionic compounds from the polymer dispersion and then adding at least one salt of a monoalkyl or dialkyl ester of a sulfonated dicarboxylic acid.

Self-adhesive articles, such as labels or protective films, are used frequently, and are also used in the outdoor sector.

In the outdoor sector the self-adhesive articles are exposed to the influence of moisture.

The action of water on the adhesive film leads to an unwanted clouding which is called water whitening.

It is known that this clouding is attributable to the presence of water-soluble ionic compounds in the adhesive film.

Therefore in EP-A-571 069 it is recommended that these ionic compounds be removed from polymer dispersions by treatment with an ion exchanger resin.

Although the resulting polymer dispersions then have an improved water whitening behavior, other of their performance properties are impaired. In particular they have poor wettability on customary substrates such as polymer films or silicone papers, and on these substrates can hardly still be uniformly applied and filmed.

The use of esters of sulfosuccinic acid as emulsifier or wetting agent is known from EP-A-1 006 106.

Polymer dispersions which exhibit improved water whitening behavior and have good wettability on a wide variety of substrates and good performance properties were an object of the present invention.

The invention accordingly provides the method defined at the outset, the polymer dispersions obtainable by the method, and the use of the polymer dispersions.

The polymer used in the method of the invention is obtainable preferably by free-radical addition polymerization of ethylenically unsaturated compounds (monomers).

The polymer is composed in particular of at least 60% by weight, preferably at least 80% by weight, more preferably at least 90% by weight of what are called principal monomers.

The principal monomers are selected from C₁-C₂₀ alkyl (meth)acrylates, vinyl esters of carboxylic acids containing up to 20 carbon atoms, vinylaromatics having up to 20 carbon atoms, ethylenically unsaturated nitrites, vinyl halides, vinyl ethers of alcohols containing 1 to 10 carbon atoms, aliphatic hydrocarbons having 2 to 8 carbon atoms and one or two double bonds, or mixtures of these monomers.

Examples include (meth)acrylic acid alkyl esters having a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Vinyl esters of carboxylic acids having 1 to 20 carbon atoms are for example vinyl laurate, vinyl stearate, vinyl propionate, Versatic acid vinyl esters and vinyl acetate.

Suitable vinylaromatic compounds include vinyltoluene, a- and p-methylstyrene, a-butylstyrene, 4-n-butylstyrene, 4-n-decylstyrene, and, preferably, styrene. Examples of nitrites are acrylonitrile and methacrylonitrile.

The vinyl halides are chloro-, fluoro- or bromo-substituted ethylenically unsaturated compounds, preferably vinyl chloride and vinylidene chloride.

Vinyl ethers include for example vinyl methyl ether or vinyl isobutyl ether. Preference is given to vinyl ethers of alcohols containing 1 to 4 carbon atoms.

Hydrocarbons having 4 to 8 carbon atoms and two olefinic double bonds that may be mentioned include butadiene, isoprene and chloroprene.

Preferred principal monomers are the C₁ to C₁₀ alkyl acrylates and methacrylates, especially C₁ to C₈ alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate, and 2-ethylhexyl acrylate, styrene, and mixtures of these monomers.

Besides the principal monomers, the polymer may include further monomers, examples being monomers having carboxylic acid, sulfonic acid or phosphonic acid groups.

Carboxylic acid groups are preferred. Examples that may be mentioned include acrylic acid, methacrylic acid, itaconic acid, maleic acid or fumaric acid.

Examples of further monomers include monomers containing hydroxyl groups, especially C₁-C₁₀ hydroxyalkyl (meth)acrylates, and (meth)acrylamide.

Additional further monomers that may be mentioned include phenyloxyethyl glycol mono(meth)acrylate, glycidyl acrylate, glycidyl methacrylate, and amino (meth)acrylates such as 2-aminoethyl (meth)acrylate.

As further monomers mention may also be made of crosslinking monomers.

In particular the polymer is synthesized from at least 60% by weight, more preferably at least 80% by weight, and very preferably at least 95% by weight of C₁ to C₂₀ alkyl (meth)acrylates.

The preparation of the polymers takes place in one preferred embodiment by emulsion polymerization, and the polymer is therefore an emulsion polymer.

For the emulsion polymerization use is made of ionic and/or nonionic emulsifiers and/or protective colloids, and/or stabilizers, as surface-active compounds.

A detailed description of suitable protective colloids is found in Houben-Weyl, Methoden der organischen Chemie, Volume XIV/1, Makromolekulare Stoffe [Macromolecular Compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are usually below 2000 g/mol. Where mixtures of surface-active substances are used the individual components must of course be compatible with one another, something which in case of doubt can be checked by means of a few preliminary tests. Preference is given to using anionic and nonionic emulsifiers as surface-active substances. Common accompanying emulsifiers are, for example, ethoxylated fatty alcohols (EO units: 3 to 50, alkyl radical: C₈ to C₃₆), ethoxylated mono-, di-, and tri-alkylphenols (EO units: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO units: 4 to 30, alkyl radical: C₁₂ to C₁₈), of ethoxylated alkylphenols (EO units: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II 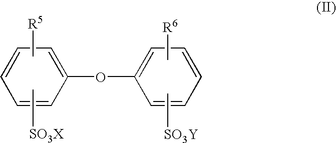
in which R⁵ and R⁶ are hydrogen or C₄ to C₁₄ alkyl and are not simultaneously hydrogen, and X and Y can be alkali metal ions and/or ammonium ions. Preferably R⁵ and R⁶ are linear or branched alkyl radicals having 6 to 18 carbon atoms or hydrogen and in particular having 6, 12, and 16 carbon atoms, with R⁵ and R⁶ not both simultaneously being hydrogen. X and Y are preferably sodium, potassium or ammonium ions, with sodium being particularly preferred. Particularly advantageous compounds are compounds 11 in which X and Y are sodium, R⁵ is a branched alkyl radical having 12 carbon atoms, and R⁶ is hydrogen or R⁵. Frequently use is made of technical-grade mixtures which contain a fraction of from 50 to 90% by weight of the monoalkylated product, an example being Dowfax® 2A1 (trade mark of the Dow Chemical Company).

Suitable emulsifiers are also found in Houben-Weyl, Methoden der organischen Chemie, Volume 14/1, Makromolekulare Stoffe [Macromolecular Compounds], Georg Thieme Verlag, Stuttgart, 1961, pages 192 to 208.

Examples of emulsifier trade names include Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25.

For the present invention ionic emulsifiers or protective colloids are preferred. With particular preference the compounds in question are ionic emulsifiers, especially salts and acids, such as carboxylic acids, sulfonic acids, and sulfates, sulfonates or carboxylates. In particular it is also possible to use mixtures of ionic and nonionic emulsifiers.

The surface-active substance is used usually in amounts of from 0.1 to 10 parts by weight, preferably from 0.2 to 5 parts by weight per 100 parts by weight of the monomers to be polymerized.

Water-soluble initiators for the emulsion polymerization are for example ammonium salts and alkali metal salts of peroxodisulfuric acid, e.g., sodium peroxodisulfate, hydrogen peroxide or organic peroxides, e.g., tert-butyl hydroperoxide.

Also suitable are what are called reduction-oxidation (Red-Ox) initiator systems.

The red-ox initiator systems are composed of at least one, usually inorganic, reducing agent and one organic or inorganic oxidizing agent.

The oxidizing component comprises, for example, the initiators already mentioned above for the emulsion polymerization.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and the salts thereof, or ascorbic acid. The red-ox initiator systems can be used together with soluble metal compounds whose metallic component is able to exist in a plurality of valence states.

Customary red-ox initiator systems are, for example, ascorbic acid/iron(II) sulfate/sodium peroxodisulfate, tert-butyl hydroperoxide/sodium disulfite, tert-butyl hydroperoxide/Na hydroxymethanesulfinate. The individual components, the reducing component for example, can also be mixtures, an example being a mixture of the sodium salt of hydroxymethanesulfinic acid and sodium disulfite.

The compounds stated are used generally in the form of aqueous solutions, the lower concentration being determined by the amount of water that is acceptable in the dispersion and the upper concentration by the solubility of the respective compound in water. In general the concentration is from 0.1 to 30% by weight, preferably from 0.5 to 20% by weight, more preferably from 1.0 to 10% by weight, based on the solution.

The amount of the initiators is generally from 0.1 to 10% by weight, preferably from 0.5 to 5% by weight, based on the monomers to be polymerized. It is also possible for two or more different initiators to be used in the emulsion polymerization.

For the polymerization it is possible to use regulators, in amounts for example of from 0 to 0.8 part by weight per 100 parts by weight of the monomers to be polymerized, by means of which molar mass is reduced. Examples of suitable compounds are those having a thiol group, such as tert-butyl mercaptan, thioglycolic acid ethylacrylic esters, mercaptoethynol, mercaptopropyltrimethoxysilane or tert-dodecyl mercaptan.

The emulsion polymerization takes place in general at from 30 to 130° C., preferably from 50 to 90° C. The polymerization medium may be composed either of water alone or of mixtures of water and liquids miscible therewith such as methanol. Preferably just water is used. The emulsion polymerization can be carried out either as a batch operation or in the form of a feed process, including staged or gradient procedures. Preference is given to the feed process, in which a portion of the polymerization mixture is introduced as an initial charge, heated to the polymerization temperature, and subjected to partial polymerization and then the remainder of the polymerization mixture is supplied to the polymerization zone, usually by way of two or more spatially separate feeds, of which one or more comprise(s) the monomers in pure form or in emulsified form, continuously, in stages or subject to a concentration gradient, during which the polymerization is maintained. In the polymerization it is also possible for a polymer seed to be included in the initial charge in order, for example, to establish the particle size more effectively.

The manner in which the initiator is added to the polymerization vessel in the course of the free-radical aqueous emulsion polymerization is known to one of ordinary skill in the art. Either it can be included in its entirety in the initial charge to the polymerization vessel or else it can be inserted continuously or in stages at the rate at which it is consumed in the course of the free-radical aqueous emulsion polymerization. For any given case this will depend both on the chemical nature of the initiator system and on the polymerization temperature. Preferably some of it is included in the initial charge and the remainder is supplied to the polymerization zone at the rate at which it is consumed.

To remove residual monomers it is usual to add initiator even after the end of the emulsion polymerization proper, i.e., after a monomer conversion of at least 95%.

The individual components can be added to the reactor, in the case of the feed process, from above, in the side, or from below, through the reactor floor.

In the case of emulsion polymerization, aqueous dispersions of the polymer having solids contents of in general from 15 to 75% by weight, preferably from 40 to 75% by weight, are obtained.

The polymer dispersions obtained include water-soluble ionic compounds.

Compounds of this kind are, for example, ionic emulsifiers, ionic constituents of initiator systems, or other ionic secondary products which are formed while the emulsion polymerization is being carried out.

By water solubility is meant a solubility of at least 200 g of the ionic compound in 1 liter of water (21° C., 1 bar).

The polymer dispersion may include in particular up to 5 parts by weight of the water-soluble ionic compounds per 100 parts by weight of the dispersed polymer. In general the amount is at least 0.3 parts by weight.

A usual amount is from 0.5 to 4, more preferably from 1 to 3, parts by weight of water-soluble ionic compounds per 100 parts by weight of polymer.

In the case of the method of the invention at least 50 mol %, preferably at least 70 mol %, more preferably at least 90 mol % of the water-soluble ionic compounds are removed from the polymer dispersion.

Methods of removing water-soluble ionic compounds from water are known.

One suitable method, for example, is a method as described in EP-A-571 069. According to that method the aqueous polymer dispersion is treated with an ion exchanger resin. Preference is given to using a mixture of an anionic and of a cationic exchanger resin, in order to catch both kinds of ions.

An example of another suitable method is that of dialysis. In dialysis the polymer particles are retained by semipermeable membranes, while the water-soluble ionic compounds diffuse through the membrane. Continual supply of water maintains a concentration gradient.

Dialysis devices are available commercially.

In diafiltration, which is likewise suitable for removing the ionic compounds, water under overpressure is passed through the dispersion. After passing through a membrane which is impervious to the dispersion particles, the water, which contains the water-soluble ionic compounds, is removed.

With the method of the invention the removal of the water-soluble ionic compounds is followed by addition of a salt of a monoalkyl or dialkyl ester of a sulfinated dicarboxylic acid.

The dicarboxylic acid is preferably a dicarboxylic acid having 4 to 8 carbon atoms, and in particular is succinic acid (HOOC—CH₂—CH₂—COOH). The dicarboxylic acid is sulfonated, i.e., substituted by at least one, preferably one, sulfonate group.

One or both carboxylic acid groups are esterified with alkanols, so that a monoalkyl or dialkyl ester is present. The alkyl groups contain preferably 2 to 20, more preferably 4 to 16, very preferably 4 to 12 carbon atoms.

Dialkyl esters are preferred.

Di-C₄-C₁₂ alkyl esters are particularly preferred, e.g., dioctyl esters or di-2-ethylhexyl esters.

Preferred cations of the salt are the alkali metal cations or the ammonium cation. In particular a) is therefore the alkali metal salt or ammonium salt of a dialkyl ester of sulfonated succinic acid.

As a particularly preferred compound mention may be made of the following: sodium di(2-ethylhexal)sulfosuccinate or the corresponding potassium or ammonium compound.

The salt of the monoalkyl or dialkyl ester can be present for example as a solution in water.

The salt, or the solution of the salt, can be added simply to the polymer dispersion and distributed, for example, by stirring.

The amount of the salt is preferably from 0.01 to 10 parts by weight per 100 parts by weight of the dispersed polymer.

The amount is in particular at least 0.1 part by weight, more preferably at least 0.3, very preferably at least 0.5 or at least 0.7 part by weight of salt per 100 parts by weight of polymer. The amount is generally not greater than 5 parts by weight, more preferably not greater than 3 parts by weight of salt per 100 parts by weight of polymer.

The polymer dispersions obtained in this way are stable on storage. When used as coating materials they exhibit improved water whitening behavior. Clouding under moisture exposure is no longer observed, or is observed hardly at all, despite the fact that the dispersions again include a water-soluble ionic compound, in the form of the salt of the mono- or dialkylcarboxylic acid.

The polymer dispersions are readily wettable and filmable on customary substrates, including in particular on polymer films.

In particular the polymer dispersions are suitable as adhesives, preferably pressure-sensitive adhesives.

The (preferably pressure-sensitive) adhesives may comprise solely the polymer or the aqueous dispersion of the polymer.

The (pressure-sensitive) adhesives may comprise further additives, such as fillers, dyes, flow agents, thickeners or tackifiers (tackifying resins); tackifiers are, for example, natural resins, such as rosins and derivatives thereof formed by disproportionation or isomerization, polymerization, dimerization, hydrogenation. These resins can be present in their salt form (with monovalent or polyvalent counterions (cations), for example) or, preferably, in their esterified form. Alcohols used for the esterification can be monohydric or polyhydric. Examples are methanol, ethanediol, diethylene glycol, triethylene glycol, 1,2,3-propanethiol, pentaerythritol.

Use is additionally made as well of hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, α-methylstyrene, vinyltoluene.

As tackifiers use is also increasingly being made of polyacrylates which have a low molar weight. Preferably these polyacrylates have a weight-average molecular weight M_{w} below 30 000. The polyacrylates are composed preferably at least 60%, in particular at least 80%, by weight of C₁-C₈ alkyl (meth)acrylates.

Preferred tackifiers are natural or chemically modified rosins. Rosins are composed predominantly of abietic acid or derivatives thereof.

The amount of the tackifiers by weight is preferably from 5 to 100 parts by weight, more preferably from 10 to 50 parts by weight, per 100 parts by weight of polymer (solids/solids).

The (pressure-sensitive) adhesive is suitable in particular for bonding substrates wherein at least one of the substrate surfaces to be bonded is a transparent polymer film.

In particular the (pressure-sensitive) adhesives of the invention are suitable for producing self-adhesive articles, such as labels, adhesive tapes or adhesive sheets, e.g., protective sheets.

The self-adhesive articles are composed in general of a backing and a layer of the adhesive applied to one or both sides, preferably one side.

The backing material can be, for example, paper, preferably transparent polymer films of polyolefins such as polyethylene, polypropylene or PVC; particular preference is given to PVC and very particular preference to plasticized PVC.

By plasticized PVC is meant polyvinyl chloride which includes plasticizers and has a reduced softening temperature. Examples of customary plasticizers are phthalates, epoxides, adipic esters. The amount of plasticizers in the plasticized PVC is generally more than 10% and in particular more than 20% by weight.

The present invention accordingly provides, in particular, self-adhesive articles comprising transparent polymer film backing material coated with a layer of the above adhesive.

To produce the layer of adhesive on the backing material it is possible for the backing material to be coated in customary fashion.

The coated substrates obtained are used for example as self-adhesive articles, such as labels, adhesive tapes or films.

The self-adhesive articles are particularly suitable for outdoor applications.

In particular it is possible to use printed self-adhesive films in the outdoor sector and it is possible for them to be stuck, for example, to advertising hoardings or vehicles of any kind.

The self-adhesive articles of the invention have good performance properties, in particular a good peel strength (adhesion) and shear strength (cohesion).

Clouding of the adhesive layer by exposure to moisture (water whitening) is not observed or is negligible. The adhesive layer therefore has a high water stability.

### EXAMPLES

Implementation of the Method

Commercially customary polymer dispersions (Acronal® A 220, DS 3556 and DS 3559) were subjected to a diafiltration.

For this the procedure was as follows:

Initial charge: 396.8 g of dispersion (dispersion diluted to 20% by weight solids content)

Operating procedure:

The dispersion is introduced into the diafiltration cell. At 21° C., with stirring (500 rpm), and with a slight overpressure (0.2 bar), H₂O is passed through the dispersion. By means of the membranes (0.1 μm, Nuclepore PC-Membrane) the eluate is guided into a collecting vessel on the underside of the cell.

Eluate conductivity, initial: 2150 μS, final: 17 μS (μS=microsiemens)

Run time: 72 h, total eluate volume: 7360 g

Diafiltration cell: Amicon Rührzelle 8400, Amicon

Membranes: polycarbonate sieve filter membrane, Nuclepore, 0.1 μm, D: 76 mm, purchased from Costar, Order No. 111505PC

Following diafiltration, 1 part by weight of Lumiten I-SC per 100 parts by weight of polymer was added. Lumiten I-SC is the diethylhexyl ester of sulfonated succinic acid.

Water whitening behavior

The polymer dispersions in a quantity of 19 g/m² (solids) were coated onto silicone paper.

The samples subjected to diafiltration without Lumiten showed poor wetting behavior.

Following addition of Lumiten the wetting of the samples on the surface to be coated was good. The samples were dried at 90° C. (3 minutes) to form homogeneous adhesive coatings.

The adhesive film was subsequently transferred to a 100 μm polyethylene film, from which test strips were cut.

The dried test strips were suspended in distilled water (21° C.). The appearance of the test strips was evaluated visually at specific intervals of time:

Rating 0: no clouding

Rating 4: completely white

TABLE 1
Water whitening

| | | | | | | | Acronal | Acronal DS | Acronal DS |
|---|---|---|---|---|---|---|---|---|---|
| | | | | | | | A 220, after | 3556, after | 3559, after |
| | | | | Acronal | Acronal | Acronal | diafiltration, | diafiltration, | diafiltration, |
| Duration of | | | | A 220, | DS 3556, | DS 3559, | +1% | +1% | +1% |
| immersion | Acronal | Acronal | Acronal | after | after | after | Lumiten I- | Lumiten I- | Lumiten I- |
| in water | A 220 | DS 3556 | DS 3559 | diafiltration | diafiltration | diafiltration | SC | SC | SC |
| 10 sec | 1 | 0 | 0 | 0 | 0 | 0 | 0 | 0 | 0 |
| 30 sec | 1 | 0 | 0 | 0 | 0 | 0 | 0 | 0 | 0 |
| 60 sec | 2 | 1 | 0 | 0 | 0 | 0 | 0 | 0 | 0 |
| 3 min | 2 | 1 | 0 | 0 | 0 | 0 | 0 | 0 | 0 |
| 5 min | 2-3 | 2 | 0 | 0 | 0 | 0 | 0 | 0 | 0 |
| 10 min | 2-3 | 2-3 | 0 | 0 | 0 | 0 | 0 | 0 | 0 |
| 20 min | 3 | 3 | 0 | 0 | 0 | 0 | 0 | 0 | 0 |
| 30 min | 3-4 | 3-4 | 0-1 | 0 | 0 | 0 | 0 | 0 | 0 |
| 40 min | 4 | 4 | 0-1 | 0 | 0 | 0 | 0 | 0 | 0 |
| 60 min | | | 1 | 0 | 0 | 0 | 0-1 | 0-1 | 0 |

1: A method of enhancing at least one performance property of an aqueous polymer dispersion comprising at least one water-soluble ionic compound, which comprises
removing at least 50 mol % of the at least one water-soluble ionic compound from the polymer dispersion, and
adding at least one salt of a monoalkyl or dialkyl ester of a sulfonated dicarboxylic acid.

2: The method of claim 1, wherein the aqueous polymer dispersion is obtained by emulsion polymerization.

3: The method of claim 1, wherein the dispersed polymer in the polymer dispersion is a polymer obtained by free-radical addition polymerization which is synthesized from at least 60% by weight of at least one principal monomer selected from the group consisting of C₁ to C₂₀ alkyl (meth)acrylates, vinyl esters of carboxylic acids comprising up to 20 carbon atoms, vinylaromatics comprising up to 20 carbon atoms, ethylenically unsaturated nitrites, vinyl halides, vinyl ethers of alcohols comprising 1 to 10 carbon atoms, aliphatic hydrocarbons comprising 2 to 8 carbon atoms and one or two double bonds, and mixtures thereof.

4: The method of claim 1, wherein the at least one water-soluble ionic compound is an ionic emulsifier.

5: The method of claim 1, wherein at least 90 mol % of the at least one water-soluble ionic compound is removed.

6: The method of claim 1, wherein the at least one ionic compound is removed by treating the dispersion with an ion exchanger resin, by diafiltration or by dialysis.

7: The method of claim 1, wherein the at least one salt of a monoalkyl or dialkyl ester of a sulfonated dicarboxylic acid is a dialkyl ester.

8: The method of claim 1, wherein the at least one salt of a monoalkyl or dialkyl ester of a sulfonated dicarboxylic acid is a dialkyl ester of sulfonated succinic acid.

9: The method of claim 1, wherein the at least one salt of a monoalkyl or dialkyl ester of a sulfonated dicarboxylic acid is added in an amount of from 0.01 to 5 parts by weight per 100 parts by weight of the dispersed polymer.

10: An aqueous polymer dispersion obtained by the method of claim 1.

11: An adhesive comprising the aqueous polymer dispersion of claim 10 and at least one additive.

12: A method of bonding two substrates, comprising bonding the two substrates with the adhesive of claim 11, wherein at least one of the substrates to be bonded with the adhesive is a transparent polymer film.

13: The method of claim 12, wherein the transparent polymer film comprises a backing material, and wherein the adhesive is applied to the transparent polymer film backing material.

14: The method of claim 13, wherein the transparent polymer film is a PVC film.

15: A self-adhesive article comprising the adhesive of claim 11.

16: The aqueous polymer dispersion of claim 10, in the form of an adhesive.

17: A method of bonding two substrates, comprising bonding the two substrates with the adhesive of claim 16, wherein at least one of the substrates to be bonded with the adhesive is a transparent polymer film.

18: The method of claim 17, wherein the transparent polymer film comprises a backing material, and wherein the adhesive is applied to the transparent polymer film backing material.

19: The method of claim 18, wherein the transparent polymer film is a PVC film.

20: A self-adhesive article comprising the adhesive of claim 16.

21: The method of claim 6, wherein the at least one ionic compound is removed by treating the dispersion with an ion exchanger resin.

22: The method of claim 6, wherein the at least one ionic compound is removed by diafiltration.

23: The method of claim 6, wherein the at least one ionic compound is removed by dialysis.
